(19) United States
(12) Patent Application Publication
(10) Pub. No.: US 2017/0162011 A1
(43) Pub. Date: Jun. 8, 2017

(54) DEVICE AND METHOD OF DETECTING DOOR/WINDOW STATUS

(71) Applicant: NATIONAL CHUNG SHAN INSTITUTE OF SCIENCE AND TECHNOLOGY, Taoyuan City (TW)

(72) Inventors: TUNG-JUNG HSU, TAOYUAN CITY (TW); FENG-YU CHANG, TAOYUAN CITY (TW); YU-SAN LIN, TAOYUAN CITY (TW); YU-CHENG CHANG, TAOYUAN CITY (TW)

(21) Appl. No.: 14/957,663

(22) Filed: Dec. 3, 2015

(51) Int. Cl. G08B 13/08

(52) U.S. Cl. CPC G08B 13/08

(57) ABSTRACT

A device of detecting a door/window status includes a signal generating unit and a signal sensing module. The signal generating unit is disposed beside a door/window to generate a position signal. The signal sensing module is disposed opposite the signal generating unit and includes a three-axis accelerometer, a three-axis magnetic force gauge and a microcontroller. The microcontroller reads the position signal generated from the signal generating unit and detection signals generated from the three-axis accelerometer and the three-axis magnetic force gauge while the door/window is operating to thereby determine the position and status of the door/window, thereby enhancing home safety. A method of detecting the door/window status with the device is further introduced.

### FIELD OF TECHNOLOGY

The present invention relates to devices and methods of detecting a door/window status and more particularly to a device and method of detecting a door/window status and determining the door/window status by detecting the strength of a signal.

### BACKGROUND

Due to economic development and technological advancement, there is an increasingly great demand for door/window protection as far as home safety is concerned. In this regard, conventional ways of detecting a door/window status fall into the following categories: vibrational sensing, switch-based sensing, and mechanical sensing.

Take vibrational sensing as an example, it is predisposed to errors because of any external force arising from a wrong collision, for example. As a result, vibrational sensing is unreliable and unpractical. Taiwan Patent M373561 discloses a magnetic spring-based switch, wherein a leaf spring made of iron is magnetically attracted to a magnet to thereby confirm that the switch is turned off; however, the security of the switch can be undermined whenever a sensing end thereof is magnetically attracted to a magnet such that the sensing end and the magnet move together. Likewise, Taiwan Patent 580177 discloses that a V-shaped spring serves as a switch, wherein a user has to insert the V-shaped spring anew in each instance of operation; as a result, in the situation where it is necessary to turn on and turn off the switch very often, the V-shaped spring lacks ease of use.

In view of the aforesaid drawbacks of the prior art, US 20070233407 discloses detection of magnetic changes, wherein a coil is wound round one side of a door/window such that the coil generates a magnetic force change for determining whether the door/winder is opened or shut; however, US 20070233407 has drawbacks as follows: although it is not necessary for the coil of US 20070233407 to be mounted anew, it is more intricate to mount the coil and a sensing device of US 20070233407 on the door/window than the magnetic spring-based switch of Taiwan Patent M373561.

### SUMMARY

In view of the aforesaid drawbacks of the prior art, it is an objective of the present invention to provide a device and method of detecting a door/window status and determining the door/window status and position through a change in a sensing signal, so as to further enhance home safety.

Another objective of the present invention is to provide a device and method of detecting a door/window status, comprising an accelerometer and a magnetic force gauge whereby the status detection is rendered precise, so as to further enhance home protection.

In order to achieve the above and other objectives, the present invention provides a device of detecting a door/window status, comprising: a signal generating unit disposed beside a door/window to generate a position signal; and a signal sensing module disposed opposite the signal generating unit and comprising a three-axis accelerometer, a three-axis magnetic force gauge and a microcontroller, wherein the microcontroller reads the position signal generated from the signal generating unit and detection signals generated from the three-axis accelerometer and the three-axis magnetic force gauge while the door/window is operating to thereby determine the position and status of the door/window, thereby enhancing home safety.

In order to achieve the above and other objectives, the present invention further provides a method of detecting a door/window status, comprising the steps of: providing a signal generating unit disposed beside a door/window to generate a position signal; and providing a signal sensing module disposed opposite the signal generating unit and comprising a three-axis accelerometer, a three-axis magnetic force gauge and a microcontroller, wherein the microcontroller reads the position signal generated from the signal generating unit and detection signals generated from the three-axis accelerometer and the three-axis magnetic force gauge while the door/window is operating to thereby determine the position and status of the door/window, thereby enhancing home safety.

### BRIEF DESCRIPTION

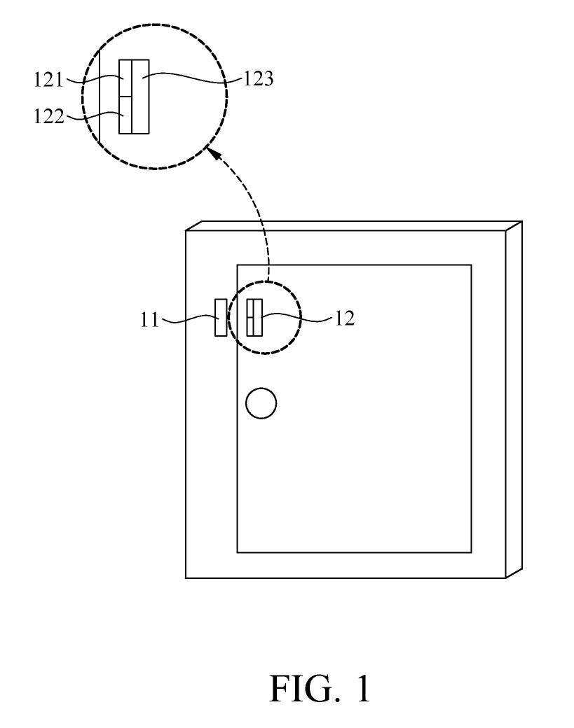

FIG. 1 is a schematic view of a device of detecting a door/window status according to the present invention;

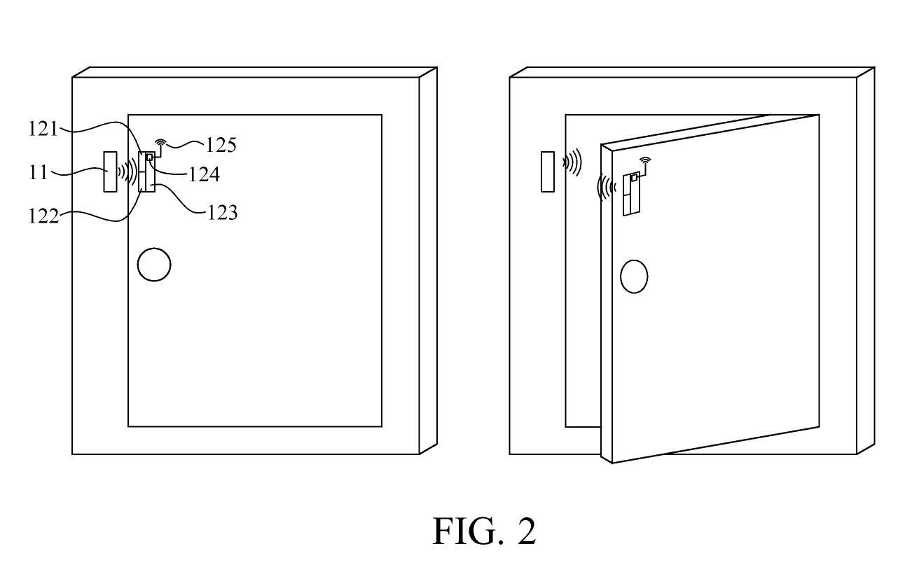

FIG. 2 is a schematic view of the operation of the device of detecting a door/window status according to the present invention;

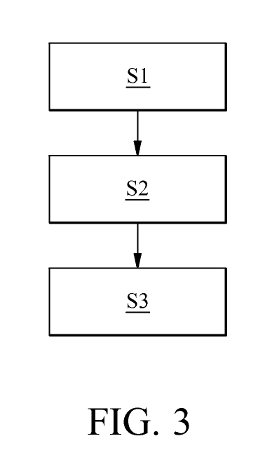

FIG. 3 is a schematic view of the process flow of a method of detecting a door/window status according to the present invention; and

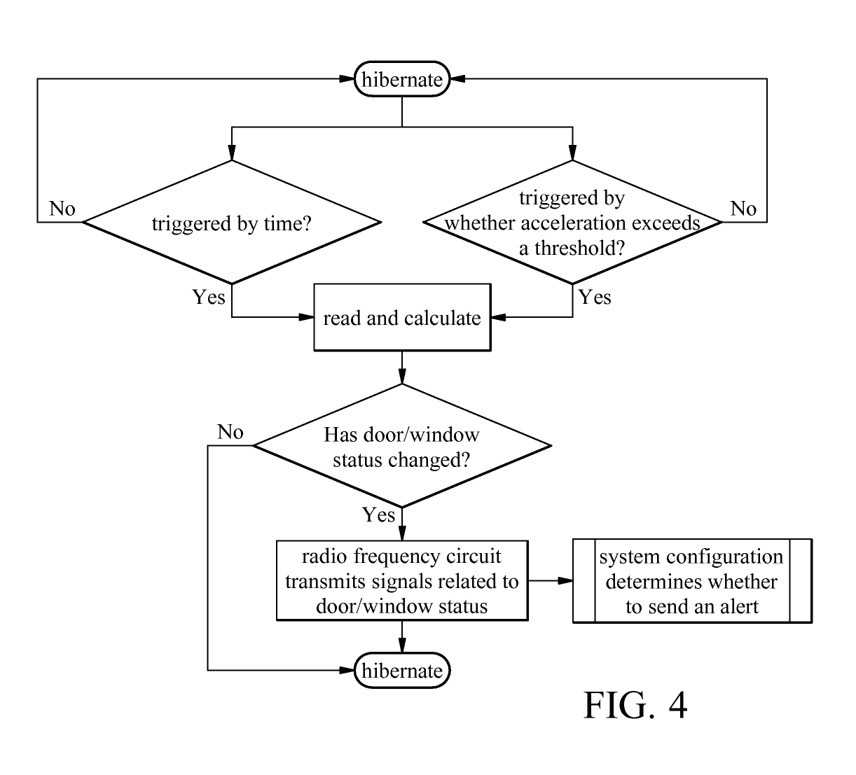

FIG. 4 is a flow chart of the detection effectuated by the method of detecting a door/window status according to the present invention.

### DETAILED DESCRIPTION

Further features and advantages of the present invention are illustrated with specific embodiments below so that a person skilled in art understands the features and advantages of the present invention.

Referring to FIG. 1, there is shown a schematic view of a device of detecting a door/window status according to the present invention. As shown in the diagram, a signal generating unit 11 is disposed on one side of a door/window to generate a position signal, and a signal sensing module 12 including a three-axis accelerometer 121, a three-axis magnetic force gauge 122 and a microcontroller 123 is disposed on the other side of the door/window to be opposite to the signal generating unit 11. The signal generating unit 11 is a magnet. The magnet generates a magnetic field with constant strength. The signal sensing module 12 determines the position and status of the door/window by detecting the magnetic field's strength.

Referring to FIG. 2, there is shown a schematic view of the operation of the device of detecting a door/window status according to the present invention. As shown in the diagram, the microcontroller 123 reads the position signal generated from the signal generating unit 11 and detection signals generated from the three-axis accelerometer 121 and the three-axis magnetic force gauge 122 while the door/window is operating to thereby determine the position and status of the door/window. The signal sensing module 12 further comprises a wireless radio frequency circuit 124 and an antenna device 125 to thereby transmit signals related to the door/window status, thereby enhancing home safety and protection.

Referring to FIG. 3, the process flow of the method of detecting a door/window status according to the present invention is described as follows:

Step S1: providing a signal generating unit to generate a position signal;

Step S2: providing a signal sensing module which comprises a three-axis accelerometer, a three-axis magnetic force gauge and a microcontroller; and

Step S3: using microcontroller to detect the position signal generated from the signal generating unit and read detection signals generated from the three-axis accelerometer and the three-axis magnetic force gauge to thereby determine the position and status of the door/window, thereby enhancing home safety.

However, the method of detecting a door/window status according to the present invention can also involve using a wireless radio frequency circuit and an antenna to transmit signals related to the position and status of the door/window to users, thereby enhancing home safety and protection. Referring to FIG. 4, there is shown a flow chart of the detection effectuated by the method of detecting a door/window status according to the present invention. As shown in the diagram, the present invention features a hibernation configuration whereby the detection of the position and status of a door/window is automatically triggered within a configured period of time, thereby enhancing home safety and protection.

Although the present invention is disclosed above by embodiments, the embodiments are not restrictive of the present invention. Any persons skilled in the art can make some changes and modifications to the embodiments without departing from the spirit and scope of the present invention. Accordingly, the legal protection for the present invention should be defined by the appended claims.

1. A device of detecting a door/window status, the device comprising:
a signal generating unit disposed beside a door/window to generate a position signal; and
a signal sensing module disposed opposite the signal generating unit and comprising a three-axis accelerometer, a three-axis magnetic force gauge and a microcontroller, wherein the microcontroller reads the position signal generated from the signal generating unit, acceleration detecting signals generated from the three-axis accelerometer and magnetic force detecting signals generated from the three-axis magnetic force gauge while the door/window is operating to thereby determine the position and status of the door/window.

2. The device of claim 1, wherein the signal generating unit is a magnet.

3. The device of claim 1, wherein the position signal relates to a magnetic field's strength.

4. The device of claim 1, wherein the signal sensing module determines the door/window status by detecting a magnetic field's strength.

5. The device of claim 1, wherein the signal sensing module further comprises a wireless radio frequency circuit and an antenna to thereby transmit signals related to the door/window status.

6. A method of detecting a door/window status, comprising the steps of:
providing a signal generating unit disposed beside a door/window to generate a position signal; and
providing a signal sensing module disposed opposite the signal generating unit and comprising a three-axis accelerometer, a three-axis magnetic force gauge and a microcontroller, wherein the microcontroller reads the position signal generated from the signal generating unit, acceleration detecting signals generated from the three-axis accelerometer and magnetic force detecting signals generated from the three-axis magnetic force gauge while the door/window is operating to thereby determine the position and status of the door/window.

7. The method of claim 6, wherein the signal generating unit is a magnet.

8. The method of claim 6, wherein the position signal relates to a magnetic field's strength.

9. The method of claim 6, wherein the signal sensing module determines the door/window status by detecting a magnetic field's strength.

10. The method of claim 6, wherein the signal sensing module further comprises a wireless radio frequency circuit and an antenna to thereby transmit signals related to the door/window status.
